(19) United States
(12) Patent Application Publication
(10) Pub. No.: US 2024/0238753 A1
(43) Pub. Date: Jul. 18, 2024

(54) ADSORBENT THAT CONTAINS POTASSIUM HYDROXIDE AND POTASSIUM CARBONATE, AND RELATED METHODS AND DEVICES

(71) Applicant: ENTEGRIS, INC., Billerica, MA (US)

(72) Inventors: Maryam Irani, Franklin, MA (US); Reena Srivastava, Franklin, MA (US)

(21) Appl. No.: 18/410,595

(22) Filed: Jan. 11, 2024

Related U.S. Application Data
(60) Provisional application No. 63/438,979, filed on Jan. 13, 2023.

(51) Int. Cl. B01J 20/04; B01D 53/14; B01J 20/20; B01J 20/30

(52) U.S. Cl. CPC B01J 20/041; B01D 53/1456; B01J 20/043; B01J 20/20; B01J 20/305; B01J 2220/42

(57) ABSTRACT

Described are adsorbent materials that are useful to remove airborne molecular contamination from a stream of gas, and that include a porous adsorbent base having potassium hydroxide ion and potassium carbonate applied to surfaces of the adsorbent base, as well as devices that include the adsorbent and related methods of preparing and using the adsorbent.

### FIELD

The present description relates to adsorbent materials that are useful to remove airborne molecular contamination from a stream of a gas, and that include a porous adsorbent base impregnated with potassium hydroxide and potassium carbonate as well as devices that include the adsorbent and related methods of preparing and using the adsorbent.

### BACKGROUND

Airborne molecular contaminants (AMC) are molecular-scale impurities that are present at low levels (e.g., “trace amounts”) in a gas, such as air, of a highly controlled and purified environment such as that of a clean room.

The presence of airborne molecular contamination in semiconductor and microelectronic device manufacturing environments has become ever more significant as dimensions of integrated circuits, disk drives, and the like become smaller and smaller. With higher and higher precision manufacturing processes, ever smaller concentrations of airborne molecular contaminants become relevant to the quality and yield of products prepared in a controlled environment.

Molecular scale chemical contaminants can be present in a gas because of various factors, such as processing history of the gas, or due to the gas being exposed to surfaces from which the gaseous molecular-scale contaminants evolve. For example, airborne molecules are released from nearly all materials present within a clean room. Molecular-scale organic and inorganic (e.g., acid, base) materials pass into the clean room environment from surfaces, processing materials, etc., that are used in the clean room. As part of the clean room environment, the molecules may eventually be deposited onto surfaces of in-process microelectronic devices. At the surface, the molecules can act as a contaminant or impurity that may have a detrimental effect to further processing of the device surface, or operation of a finished device. As an example, a contaminant may change electrical or optical properties of a manufactured device. Contaminants include molecular acids, molecular bases, molecular condensables, organic compounds, ozone, and molecular dopants, among others. Having sizes in a nanoscale range (e.g., from about 0.2 to 3.0 nanometers), airborne molecular contaminants can evade particle filters.

Continued improvements in clean room environments have greatly reduced the presence of particulate contamination, as filtration technology is capable of reducing hundreds of thousands of sub-micron particles per liter to virtually nil per liter, through the use of the highest-grade ULPA filters. However, airborne molecular contamination remains a challenge.

Airborne molecular contamination is the subject of significant research, including in the context of clean rooms and microelectronic device manufacturing. See, e.g., Lobert, Jurgen, M., Srivastana, R., and Belanger, F., “Airborne molecular contamination: Formation, impact, measurement and removal of nitrous acid (HNO₂),” ASCM 2018, p 180-185. As described, airborne molecular contamination can cause reduced yield in semiconductor processing. For example, weak acids as molecular contaminants may affect process technologies of twenty-two nanometer node processing and below. One such weak acid is nitrous acid (HNO₂ or HONO), which has no demonstrated direct impact on processes or equipment, but has nevertheless been a target for removal by airborne molecular contamination filtration. Nitrous acid (HNO₂) is commonly formed on surfaces from nitrogen dioxide (NO₂) gas, which is one of the main oxides of nitrogen formed from combustion processes and ambient air photochemistry.

### SUMMARY

The following description relates to novel adsorbents, devices, systems, and processes that can be used to remove nitrogen oxide compounds (“NOₓ compounds,” including nitrogen dioxide (NO₂)) from a flow of a gas such as air. The adsorbent includes a porous adsorbent base that is impregnated with potassium hydroxide and potassium carbonate. Useful methods involve contacting a gas with the adsorbent to allow a nitrogen oxide compound, e.g., nitrogen dioxide, to adsorb onto surfaces of the porous adsorbent. The adsorbent is effective to adsorb nitrogen oxide molecules contained in the gas to remove the nitrogen oxide molecules from the gas. The adsorbent has additionally been determined to be particularly effective at preventing adsorbed nitrogen oxide molecules from being converted to a derivative acid compound, referred to as HNOₓ, and allowing the acid compound to be released from the adsorbent.

By certain known methods of removing nitrogen oxide compounds from a gas, a challenge exists in that nitrogen oxide molecules that are adsorbed onto an adsorbent surface (e.g., granular activated carbon (GAC)), are converted to a derivative acid (HNOₓ) such as HNO₂. Nitrogen dioxide NO₂ that becomes adsorbed at an adsorbent surface, and which is then chemically converted to HNO₂, is released from the adsorbent surface as the derivative acid, e.g., HNO₂. The acid then enters an effluent stream (e.g., “filtrate”) of purified gas that flows from the adsorbent, resulting in the unwanted presence of HNOₓ (especially HNO₂) as a contaminant in the purified gas stream.

Adsorbents as described, which contain both potassium carbonate and potassium hydroxide, have now been shown to be effective to adsorb nitrogen dioxide, and to advantageously produce a relatively lower amount of acid derivatives of the nitrogen oxide compounds released from the adsorbent after nitrogen oxide is adsorbed on the adsorbent surface. For example, a relatively greater amount of nitrogen oxide compound can be adsorbed on the adsorbent before the adsorbent begins to release a significant amount of the derivative acid.

In one aspect, the invention relates to a porous adsorbent that includes: a porous adsorbent base, potassium hydroxide at surfaces of the porous adsorbent base, and potassium carbonate at surfaces of the porous adsorbent base.

In another aspect, the invention relates to a filter device that contains adsorbent. The adsorbent includes a porous adsorbent base, potassium hydroxide at surfaces of the porous adsorbent base, and potassium carbonate at surfaces of the porous adsorbent base.

In another aspect, the invention relates to a method of preparing adsorbent that includes an adsorbent base, potassium hydroxide, and potassium carbonate. The method includes: applying aqueous K₂CO₃ solution to the adsorbent base, applying aqueous KOH solution to the adsorbent base, removing water from the aqueous K₂CO₃ solution and the aqueous KOH solution applied to the porous adsorbent base.

In yet another aspect, the invention relates to a method of removing a nitrogen oxide compound from a gas. The method includes contacting the gas with porous adsorbent that includes: porous adsorbent base, and potassium hydroxide and potassium carbonate at surfaces of the porous adsorbent base

### BRIEF DESCRIPTION OF THE DRAWINGS

FIG. 1 shows an example of a filter as described.

FIG. 2 shows an example of a filter as described.

FIGS. 3A, 3B, 3C, 3D, and 3E show filtering performance data of a filter as described, and of a comparative filter.

FIGS. 4A and 4B show an example filter of the present description, and a comparative filter.

FIG. 5 shows filtering performance data of a filter as described, and of a comparative filter.

FIGS. 6A and 6B show an example filter of the present description, and a comparative filter.

FIG. 7 shows filtering performance data of a filter as described and of comparative filters.

All drawings are schematic and not to scale.

### DETAILED DESCRIPTION

Described herein are novel adsorbents, devices, systems, and processes that can be used to remove NOₓ compounds (e.g., nitrogen dioxide or “NO₂”) from a flow of gas, such as air, by contacting the gas with adsorbent material that has been treated to contain potassium hydroxide and potassium carbonate at surfaces of the adsorbent.

According to example processes, a gas that contains one or more NOₓ compounds can be caused to contact the treated adsorbent material, and the NOₓ compounds, particularly nitrogen dioxide, become adsorbed onto the surface of the adsorbent material and are removed from the gas.

Advantageously, after a NOₓ compound is adsorbed at the adsorbent surface, the adsorbent releases a relatively lower amount of acid derivates of the NOₓ compounds, such as HNO₂, when compared to the amount of acid derivative compound that is released by other adsorbents. In specific, known carbon adsorbents that are used to remove nitrogen dioxide from a gas allow the nitrogen dioxide to be converted to an acid derivative (e.g., HNO₂) at the adsorbent surface, and then allow the acid derivative to be released from the adsorbent into an exiting stream of the filtered gas. A treated adsorbent as described herein can reduce or prevent this effect. Compared to known adsorbents, an adsorbent of the present description may be capable of adsorbing a greater amount of nitrogen dioxide molecules before a significant amount of an acid derivative of the nitrogen dioxide molecule is released from the surface.

The gas that is being processed to remove the NOₓ compounds may be any gas that contains an amount of one or more nitrogen oxide compounds that are desirably removed from the gas. In a particular example, the gas is air from a clean room environment used to process semiconductor and microelectronic devices. In semiconductor processing and the microelectronics industry, as well as in other manufacturing industries, “clean rooms” include atmospheric air having a highly purified and controlled composition. For clean rooms used to process microelectronic and semiconductor devices, the clean room atmosphere is continuously processed to remove particle contaminants as well as “airborne molecular contamination” (“AMC,” also “airborne molecular contaminant”).

The air may contain typical constituents of air (approximately 78 percent nitrogen, 21 percent oxygen, and about 0.9 percent argon and 0.3 percent carbon dioxide) as well as optional water vapor. Per the present description a clean room air atmosphere also contains very low concentrations of one or more different types of airborne molecular contamination such as nitrogen oxide compounds (e.g., nitrogen dioxide), each individually present at a concentration below 100 parts per billion, or below 50 parts per billion (ppb), or below 1, 0.5, or 0.1 ppb (measured for individual contaminant molecules). The air may additionally contain other airborne molecular contaminants such as molecular acids (e.g., organic acids such as acetic acid or inorganic acids such as sulfuric acid), ammonia (NH3), or organic compounds (e.g., aromatic compounds such as toluene), also at concentrations (individually) of less than 100 parts per billion or less than 50, 10, 5, 2, 0.5, or 0.1 parts per billion (ppb). Adsorbent as described can be effective to remove contaminants such as these from air of a clean room environment and maintain a concentration of one or more of these contaminants at a maximum value in a parts-per-billion range listed above.

A typical clean room atmosphere for processing semiconductor and microelectronic products will have a relative humidity that is below 60 percent, e.g., below 50 percent, e.g., in a range from 20 to 60 percent, such as from 40 to 50 percent, at ambient temperature, e.g., approximately 22 degrees Celsius (e.g., from 20 to 25 degrees Celsius), and ambient pressure (approximately 1 atmosphere).

An amount of airborne molecular contaminant in a volume of air may be described as a percentage, or alternately in terms of parts per billion. The term “parts per billion” is used herein in a manner that is consistent with the use of this terms in the chemical arts. In this respect, parts per billion (“ppb”) is commonly used as a measure of small levels (concentrations) of an impurity in a gas, expressed as milligrams of the impurity per liter fluid (mg/L), and measures the mass of the contaminant per volume of the fluid. One part per billion (“ppb”) is equal to 1×10⁻⁹ or 0.0000001 percent of a total substance.

The novel adsorbent material includes a solid porous adsorbent “base” structure that can be used as a porous substrate to support a combination of potassium hydroxide and potassium carbonate at surfaces of the base structure in a manner that allows the potassium hydroxide and the potassium carbonate-containing adsorbent to be effective as an adsorbent to remove impurities that include NOₓ compounds, including nitrogen dioxide, from a flow of gas.

The porous adsorbent base may be any useful porous adsorbent material to which potassium hydroxide and potassium carbonate may be added, after which the porous adsorbent base and the applied potassium hydroxide and potassium carbonate will be effective as an adsorbent material to remove airborne molecular contaminants from a flow of gas.

Examples of adsorbent materials that may be useful as a porous adsorbent base include known types of porous adsorbent materials, e.g.: carbon-based adsorption media, polymeric adsorption media, silica, etc. Specific examples include metal organic frameworks (“MOF”), specifically including zeolitic imidazolate framework (“ZIF”) adsorbents; zeolites (aluminosilicates), silica and silica-based particles; alumina and alumina-based particles; and porous carbon adsorbent particles, which include carbon adsorbent materials commonly referred to as “activated carbon particles” among other types of carbon particles.

Non-limiting examples of porous carbon adsorbent materials that are useful as a porous adsorbent base include: carbon formed by pyrolysis of synthetic polymer such as a hydrocarbon, halocarbon (e.g., chlorocarbons), or hydrohalocarbon resin, e.g., polyacrylonitrile, polystyrene, sulfonated polystryrene-divinylbenzene, polyvinylidene chloride (PVDC), etc.; cellulosic char; charcoal; and activated carbon formed from natural source materials such as coconut shells, pitch, wood, petroleum, coal, etc.

A porous adsorbent base may be in any shape, form, size, etc., to support the potassium hydroxide and potassium carbonate at surfaces of the base, with the base structure and the added combination of potassium hydroxide and potassium carbonate being effective to adsorb airborne molecular contaminants from a gas. The size, shape, and physical properties of a porous adsorbent base, such as pore features (pore size, porosity, surface area), can affect the capacity of the base for adsorbing airborne molecular contaminants.

For example, an adsorbent base of activated carbon particles can be characterized by a relatively high surface area, such as a surface area of at least 500, 600, or 700 square meters per gram, e.g., a surface area in a range from 700 to 1000 square meters per gram, or higher. This type of surface area measurement can be performed by known methods, such as by a nitrogen BET surface area measurement technique.

The pores of an adsorbent base may have any useful pore size, meaning any pore size that will allow for desired adsorption performance. Pore sizes of adsorbent materials are classified in general ranges based on average pore sizes of a collection of particles. Particles that have an average pore size of greater than 50 nanometers (nm) are typically referred to as macroporous. Particles that have an average pore size in a range from 2 to 50 nanometers (nm) are typically referred to as mesoporous particles. Particles that have an average pore size of less than 2 nanometers are typically referred to as microporous. These terms are defined by IUPAC terminology. Base particles as used according to the present description may have average pore sizes, or pore size ranges, that fall within any of these size range designations.

A porous adsorbent base is treated with useful amounts of a combination of potassium hydroxide (KOH) and potassium carbonate (K₂CO₃) to cause the potassium hydroxide and potassium carbonate to become located at surfaces within the pores of the porous adsorbent, i.e., to be “impregnated” into the porous adsorbent base. By one useful technique, the potassium hydroxide and the potassium carbonate may be applied to the porous adsorbent by an incipient wet impregnation method. By these techniques, an aqueous solution is prepared to contain the potassium hydroxide, and a separate aqueous solution is prepared to contain the potassium carbonate. The aqueous solutions are incorporated (e.g., “impregnated”) into the porous adsorbent, e.g., separately, with the aqueous solutions penetrating into the pores of the porous adsorbent. The solutions within the pores of the porous adsorbent are dried to remove the water, and the potassium hydroxide and potassium carbonate remain at the porous interiors of the adsorbent after the water of the aqueous solutions is removed. The potassium hydroxide and potassium carbonate impregnated into the porous base may be present partially or entirely in an ionic form; with reference to the potassium hydroxide, the surface will contain potassium ions (K⁺) and hydroxide ions (OH⁻); with reference to the potassium carbonate, the surface will contain potassium ions (K⁺), carbonate ions (CO₃⁻).

According to a particular method, the aqueous potassium carbonate solution may be first applied and dried by removing water from the solution. The aqueous potassium hydroxide solution may be applied after the potassium carbonate solution has been dried. The aqueous potassium hydroxide solution then is dried by removing water.

By other variations of a wet impregnation technique, the aqueous solutions may be applied in a different order, such as by applying the potassium carbonate solution first, then drying the solution, then applying the potassium hydroxide solution and drying the potassium hydroxide solution. In still a different variation a single aqueous solution that contains both potassium hydroxide and potassium carbonate may be applied in a single application, then dried.

Advantageously, a wet impregnation method may be useful to apply an aqueous solution of potassium hydroxide or potassium carbonate (or both) in a highly efficient manner, and without the need for pressurization or agitation. In an example method, one or more aqueous solutions can be applied to the porous adsorbent base by a useful application method, such as spraying. An aqueous solution is drawn into and penetrates the porous adsorbent without the need for an excess amount of the solution and without the need for elevated temperature, agitation, or applied pressure. The efficient nature of the wet impregnation step avoids the need for an excess amount of an aqueous solution to be applied to the porous adsorbent, and reduces the amount of waste of the aqueous solution.

The aqueous potassium carbonate solution and the aqueous potassium hydroxide solution, or a solution that contains both, may be applied to the adsorbent with the aqueous solution and with the adsorbent base at ambient temperature. E.g., when an aqueous solution is applied to the adsorbent base: the adsorbent base may be at a temperature in a range from 20 to 25 degrees Celsius and the aqueous solution may be at a temperature in a range from 20 to 25 degrees Celsius.

A step of drying the applied aqueous solution may be performed at any useful temperature and for an amount of time that will be effective to fully remove water from the aqueous solution, e.g., a temperature in a range of 100 to 200 degrees Celsius, and an amount of time in a range of multiple hours (e.g., in a range from 5 to 20 hours).

An adsorbent material that has been treated with potassium hydroxide, potassium carbonate, or both, can be identified by chemical analytical techniques and equipment. For example, hydroxide ions (OH⁻) and carbonate ions (CO₃⁻) can be detected at an adsorbent surface by Fourier-transform infrared spectroscopy (FTIR) techniques. Potassium ion (K⁺) ion can be detected at an adsorbent surface by ion chromatography (IC).

The amounts and the relative amounts of potassium carbonate and potassium hydroxide that are added to the porous adsorbent base can be amounts that are useful to provide a useful capacity to adsorb a nitrogen oxide compound such as nitrogen dioxide. In preferred examples, the amounts of potassium carbonate and potassium hydroxide produce improved adsorption performance relative to comparable adsorbent that does not contain potassium hydroxide. An adsorbent can contain amounts and relative amounts of potassium carbonate and potassium hydroxide that result in an increased capacity to adsorb a nitrogen oxide compound such as nitrogen dioxide, compared to a comparable adsorbent that contains potassium carbonate and no potassium hydroxide. Additionally, compared to the adsorbent that does not contain potassium hydroxide, the adsorbent that contains both potassium carbonate and potassium hydroxide may adsorb a greater amount of nitrogen oxide molecules such as nitrogen dioxide before the adsorbent begins to release a significant amount of a derivative acid of the nitrogen oxide molecule such as HNO₂, e.g., the adsorbent that contains both potassium carbonate and potassium hydroxide has a longer “breakthrough time” for the derivative acid such as HNO₂ compared to the breakthrough time of the adsorbent that contains only potassium carbonate.

Example adsorbents may contain from 10 to 40 weight percent potassium hydroxide and from 60 to 90 weight percent potassium carbonate based on total weight potassium hydroxide and potassium carbonate; e.g., from 15 to 35 weight percent potassium hydroxide and from 65 to 85 weight percent potassium carbonate based on total weight potassium hydroxide and potassium carbonate.

The adsorbent can be prepared to contain a combination of potassium hydroxide and potassium carbonate. A useful adsorbent and may optionally contain additional added chemical components such as other salts, acids, bases, etc., including additional potassium compounds. According to certain useful examples, however, an adsorbent may contain only potassium carbonate and potassium hydroxide, and no other potassium compounds and no other additional applied chemical materials. The chemicals added to the adsorbent may comprise, consist of, or consist essentially of potassium hydroxide and potassium carbonate with no other added potassium compounds, or no other added chemical compounds, or with only a small or insignificant amount of other potassium compounds or other chemical compounds.

Example adsorbents may contain at least 90, 95, 98, or 99 weight percent potassium carbonate and potassium hydroxide based on total weight of all potassium compounds applied to the adsorbent, e.g., less than 10, 5, 2, or 1 weight percent of potassium compounds different from potassium hydroxide and potassium carbonate.

Example adsorbents may contain at least 90, 95, 98, or 99 weight percent potassium carbonate and potassium hydroxide based on total weight of all chemical compounds applied to the adsorbent, e.g., less than 10, 5, 2, or 1 weight percent of chemical compounds different from potassium hydroxide and potassium carbonate.

An adsorbent as described may be used in an adsorbent bed, filter membrane, or other form of a filter product or apparatus either alone or in combination with one or more additional adsorbent materials. A second type of adsorbent that may be combined with adsorbent as described may be, e.g., activated carbon adsorbent, MOF, zeolite, ZIF, polymeric, etc., or an ion-exchange resin (either cation-exchange resin or anion-exchange resin).

Ion-exchange resins are known materials that are capable of adsorbing and desorbing ionic compounds. Example ion-exchange resins are made of polymer, e.g., crosslinked polystyrene, and include ion-exchanging sites as part of the polymer. Ion-exchange resins may be in the form of polymeric beads or polymeric membranes. Various types of ion-exchange resins are known, and differ with respect to the functional groups of the polymer constituent, including: strongly acidic ion-exchange resins that contain sulfonic acid functional groups, e.g., sodium polystyrene sulfonate (polyAMPS); strongly basic ion-exchange resins, typically featuring quaternary amino functional groups, for example, trimethylammonium groups; weakly acidic ion-exchange resins, typically including carboxylic acid groups; and weakly basic ion-exchange resins, which can include primary, secondary, or tertiary amino groups, e.g. polyethylene amine.

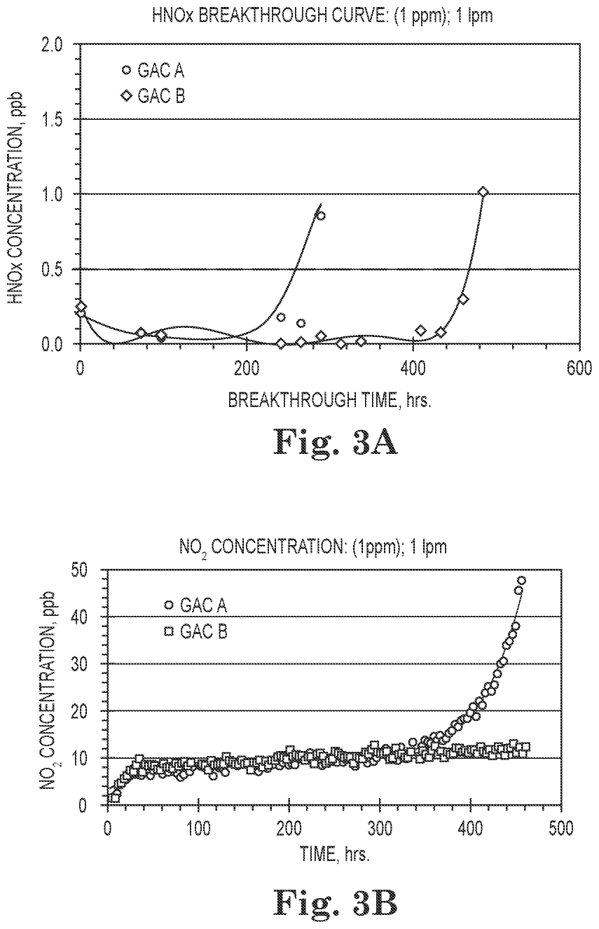

In some example products, the adsorbent of the present description (containing potassium carbonate and potassium hydroxide) may be present in a blended combination or physical mixture of the adsorbent with a different adsorbent such as an ion-exchange resin, and gas can be flowed through the mixture to contact both adsorbents of the mixture at the same time. See, for example, layer 62 of multi-layer filter 60 of FIG. 2. Ion-exchange resin can be combined with adsorbent as described, that contains potassium hydroxide and potassium carbonate, to form a mixture of the two adsorbents that contains any useful relative amounts of the two adsorbents, such as a ratio (by weight) in a range from 90:10 to 10:90, or a range from 25:75 to 75:25, or from 40:60 to 60:40.

Alternately, the described adsorbent may be present as a single (only) adsorbent in a filter bed or membrane, and a separate layer or bed of a filter system can contain a different adsorbent. The two different layers or beds of adsorbent can be arranged in series to allow gas to flow first through one type of adsorbent, then through a second type of adsorbent. See, for example, multi-layer filter, 60 of FIG. 2.

An adsorbent as described can be included in a filter assembly or a filter system (referred to generally as a “filter”) to be used to remove one or more airborne molecular contaminants from a gas (e.g., air) by contacting the gas with the adsorbent. An airborne molecular contaminant that is present in the gas becomes adsorbed on the surface of the adsorbent, and the molecular contaminant is separated from the gas. The gas flows from the filter as a filtrate that includes a reduced concentration of the airborne molecular contaminant compared to a concentration of the contaminant in the gas before the gas has contacted the filter.

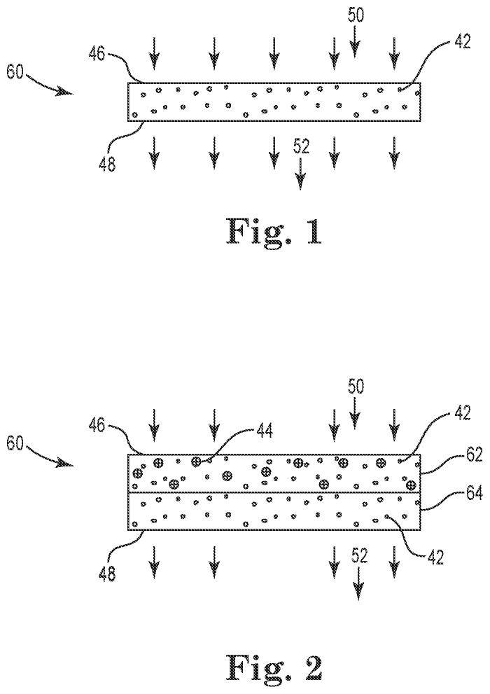

An example of a filter layer may have adsorbent that is only (consists of or consists essentially of) adsorbent that contains potassium hydroxide and potassium carbonate. Sec, e.g., FIG. 1. Another example of a filter layer may contain a mixture of adsorbent that contains potassium hydroxide and potassium carbonate, with a different adsorbent such as cation-exchange resin. See FIG. 2. A filter or a filter system may contain two layers of different adsorbent, such as: a layer that contains adsorbent that is only (consists of or consists essentially of) adsorbent that contains potassium hydroxide and potassium carbonate; and a layer that contains a blend of adsorbent that contains potassium hydroxide and potassium carbonate, with a different adsorbent such as cation-exchange resin. See FIG. 2.

In example processes, an airborne molecular contaminant may be present in a gas, before contacting the adsorbent, at a concentration (individually) of less than 10 parts per million, less than 5 parts per million, less than 1 part per million, or less than 500 parts per billion or less than 100, 50, 10, 5, 1, or 0.5 parts per billion (ppb). After the gas contacts the adsorbent as part of a filter and an amount of airborne molecular contaminant is removed from the gas, the gas that exits the filter (or “filtrate”) may contain a significantly-reduced amount of a contaminant (considered individually), e.g., the amount of the contaminant may be reduced by at least 50, 70, 80, 90, or 95 percent or greater. Stated in terms of concentration, a filtrate may contain one or more airborne molecular contaminants at a concentration (individually) of less than 10 parts per billion or less than 1, 0.5, or 0.1 parts per billion (ppb).

FIG. 1 shows example filter 60 that includes inlet 46, outlet 48, and adsorbent 42 between the inlet and the outlet. Inlet 46 allows gas 50 to flow into an interior of filter 60 to contact adsorbent 42. Gas 50 may be any gas that contains one or more airborne molecular contaminants such as NO₂, e.g., air from a clean room environment used to process semiconductor and microelectronic devices. The one or more airborne molecular contaminants become adsorbed onto adsorbent particles 42 as the gas passes through filter 60 and contacts adsorbent 42. The gas exits filter 60 as filtrate 52, containing a reduced concentration of the one or more airborne molecular impurities.

FIG. 2 shows an example of a filter that contains two different types of adsorbents: adsorbent particles 42 that contain a combination of potassium carbonate and potassium hydroxide; and cationic exchange resin particles 44. Referring to FIG. 2, example filter 60 includes inlet 46, outlet 48, and two layers (or “segments” or “beds”) (62, 64) of adsorbent between the inlet and the outlet. Layer 62 is located (as illustrated) upstream from layer 64. Layer 62 contains a physical mixture of two different types of adsorbents, e.g.: adsorbent 42, which contains potassium hydroxide and potassium carbonate, and adsorbent 44 (a “+” inside of a circle) in the form of a cationic exchange resin. Layer 64 contains only (e.g., consists of or consists essentially of) adsorbent 42, which contains potassium hydroxide and potassium carbonate.

Inlet 46 allows gas 50 to enter filter 60 and contact adsorbents 42 and 44 of layer 62, then to contact adsorbent 42 of layer 64. Gas 50 may be any gas that contains one or more airborne molecular contaminants such as NO₂, e.g., air from a clean room environment used to process semiconductor and microelectronic devices. The one or more airborne molecular contaminants become adsorbed onto particles 42 or 44 as the gas passes through filter 60 and contacts adsorbents 42 and 44. The gas exits filter 60 as filtrate 52, containing a reduced concentration of the one or more airborne molecular impurities.

### Example 1

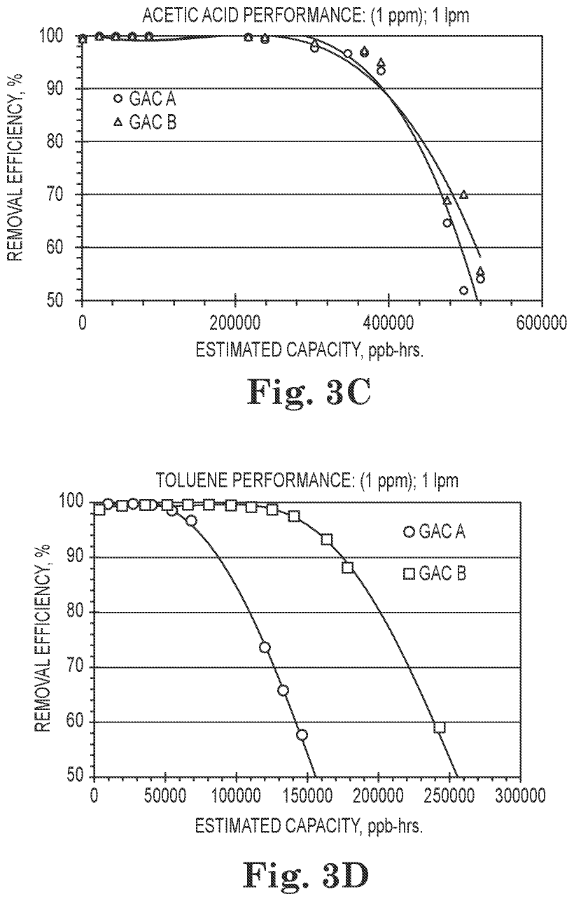

FIG. 3A shows filtering performance of single layer filter (Example 1 or “GAC B”) that contains an example of adsorbent of the present description in the form of activated carbon adsorbent that contains a combination of potassium hydroxide and potassium carbonate at surfaces of the adsorbent. A “Comparative Adsorbent” (“GAC A”) is a single layer activated carbon adsorbent that contains only potassium carbonate and no potassium hydroxide.

The graphs at FIGS. 3A and 3B show that the single layer filter that contains inventive Example 1 adsorbent (GAC B) has improved performance with respect to adsorbing NOₓ, and with respect to a reduced (delayed) release of HNOₓ after adsorbing NOₓ.

Both filters were contacted with a flow of air that contained NOₓ in a concentration of 1 ppm, at a rate of 1 liter per minute. Each of the single-layer filters adsorbed NOₓ, and for a period of hours both filters did not release a significant amount of HNOₓ. After an amount of time adsorbing NOₓ, each filter eventually began to release an increasing amount of HNOₓ. (The time at which this occurred may be referred to as a “breakthrough time.”) After approximately 200 hours, the Comparative adsorbent (GAC A) began releasing increased amounts of HNOₓ, e.g., greater than 0.5 ppb into a filtrate stream. The amount of time during which the Example 1 adsorbent adsorbed NOₓ without releasing HNOₓ at a concentration of at least 0.5 ppm was significantly longer.

Referring to FIG. 3B, this graph shows that adsorbent GAC B has a better capacity for NO₂ removal compared to GAC A. Regarding the performance of GAC A, the graph shows that the concentration of NO₂ in a filtrate increased sharply after the adsorbent was exposed to the flow of NO₂ gas for approximately 350 hours. In contrast, the GAC B adsorbent did not produce this increase in concentration of NO₂ gas in the filtrate in the same amount of time, indicating that the GAC B adsorbent has a higher capacity to adsorb NO₂.

FIG. 3C compares the performance of GAC A and GAC B for adsorbing acetic acid. The results show that adsorbent GAC B has an effective capacity for adsorbing acetic acid.

FIG. 3D compares the performance of GAC A with GAC B for adsorbing toluene. The results show that adsorbent GAC B has a significantly greater capacity for adsorbing toluene, compared to adsorbent GAC A.

FIG. 3E compares the performance of GAC A with GAC B for adsorbing SO₂. The results show that adsorbent GAC B has a significantly greater capacity for adsorbing SO₂ compared to adsorbent GAC A.

Example 1 shows that an example adsorbent of the present description (GAC B) has an increased capacity to adsorb NOₓ compounds compared to a comparable adsorbent (GAC A) that comprises potassium carbonate and no potassium hydroxide, and that the Example 1 adsorbent also produces an improved (reduced or delayed) release of HNOₓ as shown by a longer Breakthrough time. Example 1 also shows that the GAC B adsorbent is effective for adsorbing non-NOₓ molecular contaminants that include acetic acid, toluene, and SO₂.

### Example 2

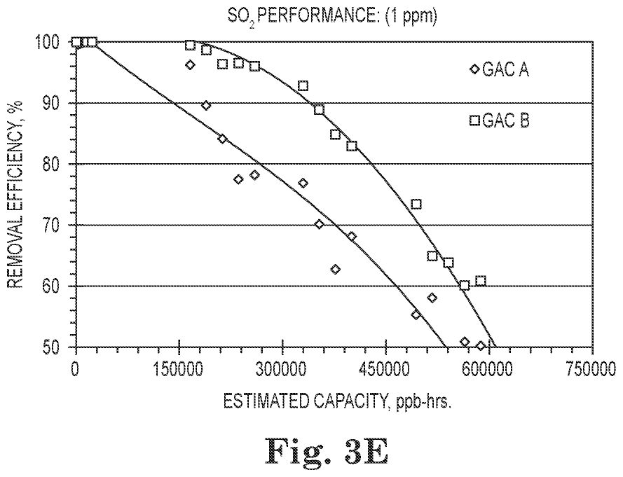

In this example, an example filter (Example 2, “Media B”) contains two layers that contain adsorbent. As shown at FIG. 4B, the Example 2 filter 80 includes a first layer 82 that contains activated carbon adsorbent 84 treated with potassium hydroxide and potassium carbonate (GAC B, 67 weight percent), in combination with cationic exchange resin 86 (33 weight percent). The second layer 90 contains only activated carbon adsorbent 84 treated with potassium hydroxide and potassium carbonate (GAC B).

A two-layer Comparative filter (Comparative Example 2 or “Media A”) 100 includes a first layer 102 that contains activated carbon adsorbent 104 treated with potassium carbonate only (no potassium hydroxide) (GAC A). The second layer 106 contains the activated carbon adsorbent 104 (GAC A) treated with potassium carbonate only (no potassium hydroxide) (31 weight percent) in combination with cationic exchange resin 86 (69 weight percent). See FIG. 4A.

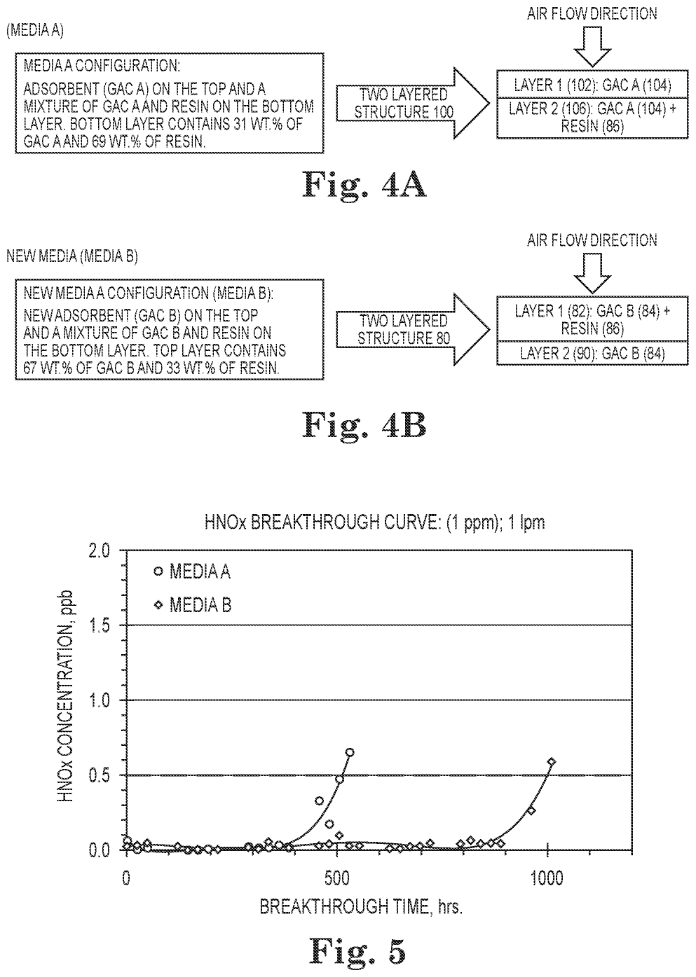

The Example 2 two-layer filter and the Comparative 2 two-layer filter were tested for performance against each other and the results are shown at FIG. 5. During testing, both two-layer filters were contacted with a flow of air that contained NOₓ in a concentration of 1 ppm, at a rate of 1 liter per minute.

For the Example 2 filter (Media B, see FIG. 4B), the air was first contacted with the first layer, 82, which contained the activated carbon adsorbent 84 treated with potassium hydroxide and potassium carbonate in combination with cationic exchange resin 86. The air passed through the first layer, 82, then passed into and through the second layer 90 containing the treated activated carbon adsorbent 84 with no cationic exchange resin.

For the Comparative 2 filter, the air was first contacted with the first layer 102, which contained the activated carbon adsorbent 104 treated with potassium carbonate only and not with potassium hydroxide, and no cationic exchange resin. The air passed through the first layer 102, then passed into and through the second layer 106, which contained the activated carbon adsorbent 104 treated with potassium carbonate only (no potassium hydroxide), in combination with a cationic exchange resin 86.

The graph at FIG. 5 shows that the Example 2 filter (Media B) has improved performance relative to the Comparative 2 filter (Media A) in releasing a reduced or delayed amount of HNOₓ after adsorbing NOₓ. Both of the two-layer filters were contacted with identical flows of air that contained NOₓ in a concentration of 1 ppm, at a rate of 1 liter per minute. Each two-layer filter effectively adsorbed the NOₓ, and for a period of hours both filters did not release a significant amount of HNOₓ. After approximately 500 hours, the Comparative 2 filter began releasing increasing amounts of HNOₓ. The amount of time that the Example 2 filter continued to adsorb NOₓ without releasing HNOₓ was significantly longer, i.e., approximately 1000 hours.

### Example 3

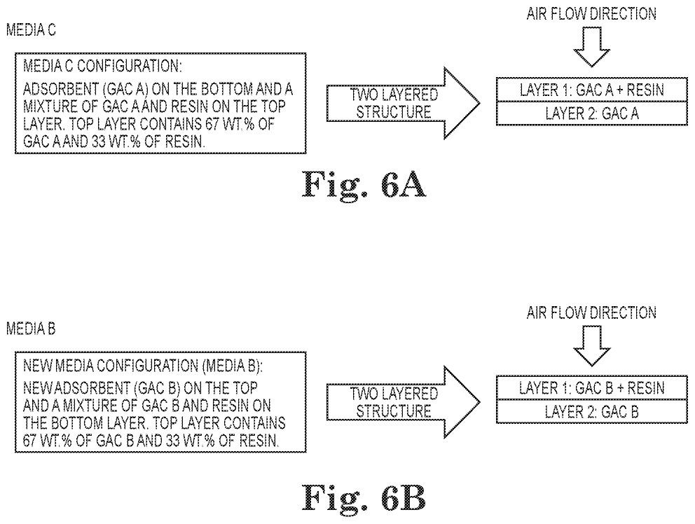

In this example, Media B, containing inventive adsorbent, is compared to a different comparative example filter (“Media C”) that contains two filter layers. See FIGS. 6A and 6B. In FIG. 6A, Media C, top layer contains 67 weight percent GAC A and 33 weight percent resin. Media B is the same Media B as in Example 2 (see FIG. 4B).

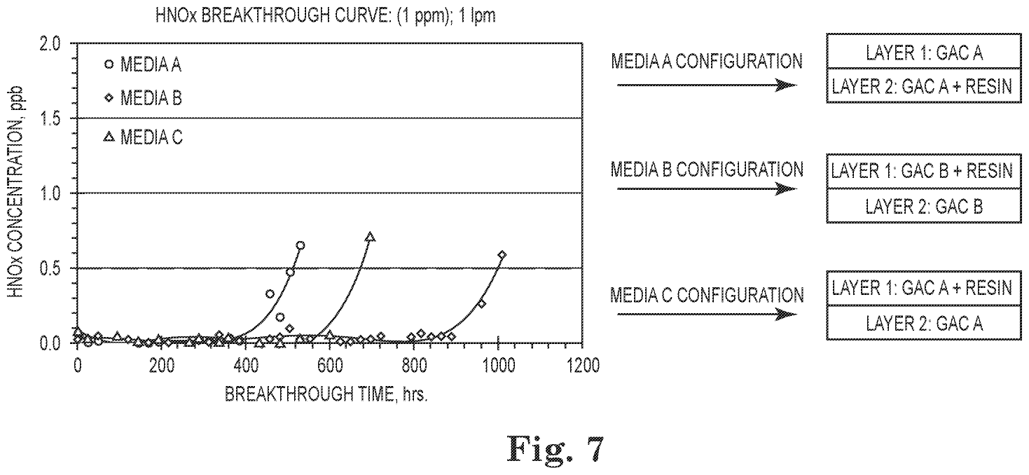

As shown at FIG. 7, Media B (containing inventive adsorbent) performs better than both of Media A and Media C.

### Adsorbent Preparation Method

To prepare the adsorbent, certain percentages of K₂CO₃ and KOH were incorporated in activated carbon through incipient impregnation method in two steps. Firstly, a 27.1 g of a coconut shell-derived granular activated carbon (GAC) was placed in a Petri dish and treated with 45 mL of K₂CO₃ solution, which was prepared by adding 2.1 g of K₂CO₃ in 45 ml of DI water. The prepared K₂CO₃ solution was distributed (sprayed) to the carbon by a syringe, allowed to sit in contact with the carbon at room temperature for 6 hours, then placed in an oven at 150° C. for 16 hours, and then cooled to room temperature to get ready for the second step. Next, a KOH solution was prepared by adding 0.8 g of KOH in 45 ml DI water. The KOH solution was distributed (sprayed) to the carbon, allowed to sit in contact with the carbon at room temperature for 6 hours, then placed in an oven to dry at 120° C. for 16 hours.

### Experimental Test Method

The adsorbent was tested under a continuous gas stream of NOₓ containing ˜1 ppm of NO₂, and ˜10 ppb of NO in air with relative humidity of 45 percent. Measurements of nitrous acid, nitric acid, nitrite, and nitrate are carried out by wet impinger method, where the upstream and downstream gas streams are bubbled through water to dissolve water-soluble compounds such as acids (e.g., HNO₂, and HNO₃) in the water. By running the gas streams through the water for at least an hour, the water-soluble compounds accumulated in the water and were detected by ion chromatography (IC). More details about wet impinger method were explained by Lobert, et al., Virtual NOₓ—A measurement artifact in wet impinger air sampling, Jurgen Lobert, Anatoly Grafer, Oleg Kishkovich, Entegris Inc., 2006. In addition, the upstream and downstream gas streams continuously were recorded by a gas analyzer (Model 17i, Thermo Scientific).

1. Porous adsorbent comprising:
a porous adsorbent base,
potassium hydroxide at surfaces of the porous adsorbent base, and
potassium carbonate at surfaces of the porous adsorbent base.

2. The adsorbent of claim 1, wherein the porous adsorbent base comprises carbon adsorbent.

3. The adsorbent of claim 1, wherein the adsorbent comprises from 10 to 40 weight percent potassium hydroxide and from 60 to 90 weight percent potassium carbonate based on total weight potassium hydroxide and potassium carbonate.

4. The adsorbent of claim 1, wherein the adsorbent exhibits increased capacity to adsorb nitrogen dioxide (NO₂) compared to a comparable adsorbent that comprises potassium carbonate and no potassium hydroxide.

5. The adsorbent of claim 1, wherein the adsorbent exhibits reduced release of derivative acid of adsorbed nitrogen dioxide compared to a comparable adsorbent that comprises potassium carbonate and no potassium hydroxide.

6. The adsorbent of claim 1, prepared by a method comprising:
applying aqueous K₂CO₃ solution to the porous adsorbent base,
removing water from the aqueous K₂CO₃ solution applied to the porous adsorbent base,
applying aqueous KOH solution to the porous adsorbent base,
removing water from the aqueous KOH solution applied to the porous adsorbent base.

7. The adsorbent of claim 6, the method comprising, in order:
applying aqueous K₂CO₃ solution to the porous adsorbent base,
then removing water from the aqueous K₂CO₃ solution applied to the porous adsorbent base,
then applying aqueous KOH solution to the porous adsorbent base,
then removing water from the aqueous KOH solution applied to the porous adsorbent base.

8. A method of removing nitrogen dioxide (NO₂) from air that contains nitrogen dioxide, the method comprising contacting the air with adsorbent of claim 1.

9. A filter device that contains adsorbent comprising:
a porous adsorbent base,
potassium hydroxide at surfaces of the porous adsorbent base, and
potassium carbonate at surfaces of the porous adsorbent base.

10. The device of claim 9, wherein the porous adsorbent base comprises activated carbon.

11. The device of claim 9, comprising:
a first interior comprising a first interior inlet, a first interior outlet, and the adsorbent comprising:
a porous adsorbent base,
potassium hydroxide at surfaces of the porous adsorbent base, and
potassium carbonate at surfaces of the porous adsorbent base; and
a second interior comprising a second interior inlet, a second interior outlet, and second adsorbent;
wherein the second interior inlet faces the first interior outlet.

12. The device of claim 11, wherein the first interior contains a combination of:
adsorbent comprising
a porous adsorbent base,
potassium hydroxide at surfaces of the porous adsorbent base, and
potassium carbonate at surfaces of the porous adsorbent base; and
cationic exchange resin.

13. The device of claim 11, wherein the second adsorbent comprises:
a porous adsorbent base,
potassium hydroxide at surfaces of the porous adsorbent base, and
potassium carbonate at surfaces of the porous adsorbent base.

14. A method of preparing adsorbent that comprises adsorbent base, potassium hydroxide, and potassium carbonate, the method comprising:
applying aqueous K₂CO₃ solution to the adsorbent base,
applying aqueous KOH solution to the adsorbent base,
removing water from the aqueous K₂CO₃ solution and the aqueous KOH solution applied to the porous adsorbent base.

15. The method of claim 14, comprising, in order:
applying the aqueous K₂CO₃ solution to the porous adsorbent base,
then removing water from the aqueous K₂CO₃ solution applied to the porous adsorbent base,
then applying aqueous KOH solution to the porous adsorbent base,
then removing water from the aqueous KOH solution applied to the porous adsorbent base.

16. The method of claim 14, comprising:
applying the aqueous K₂CO₃ solution at a temperature in a range from 20 to 25 degrees Celsius,
applying the aqueous KOH solution at a temperature in a range from 20 to 25 degrees Celsius.

17. The method of claim 14, wherein the porous adsorbent base comprises activated carbon adsorbent.

18. The method of claim 14, wherein the adsorbent comprises from 10 to 40 weight percent potassium hydroxide and from 60 to 90 weight percent potassium carbonate based on total weight potassium hydroxide and potassium carbonate.

19. A method of removing a nitrogen oxide compound from a gas, the method comprising contacting the gas with porous adsorbent comprising: porous adsorbent base, and potassium hydroxide and potassium carbonate at surfaces of the porous adsorbent base.

20. The method of claim 19, wherein the adsorbent comprises from 10 to 40 weight percent potassium hydroxide and from 60 to 90 weight percent potassium carbonate based on total weight potassium hydroxide and potassium carbonate.

21. The method of claim 19, wherein the adsorbent exhibits increased capacity to adsorb nitrogen dioxide compared to a comparable adsorbent that comprises potassium carbonate and no potassium hydroxide.

22. The method of claim 19, wherein the adsorbent exhibits reduced release of adsorbed HNO₂ compared to a comparable adsorbent that comprises potassium carbonate and no potassium hydroxide.

23. The method of claim 19, wherein the gas is air that contains nitrogen dioxide in an amount below 1 part per million, and the method removes at least 90 percent of the nitrogen dioxide.

24. The method of claim 19, wherein the gas is air that contains acetic acid in an amount below 1 part per million, and the method removes at least 90 percent of the acetic acid.

25. The method of claim 19, wherein the gas is air that contains toluene in an amount below 1 part per million, and the method removes at least 90 percent of the toluene.

26. The method of claim 19, wherein the gas is air that contains SO₂ in an amount below 1 part per million, and the method removes at least 90 percent of the SO₂.

27. The method of claim 19, comprising:
contacting the gas with a first volume of adsorbent, the first volume of adsorbent comprising a mixture that comprises:
porous adsorbent comprising: porous adsorbent base, and potassium hydroxide and potassium carbonate at surfaces of the porous adsorbent base, and
ion-exchange resin,
then contacting the gas with a second volume of adsorbent that comprises: porous adsorbent base, and potassium hydroxide and potassium carbonate at surfaces of the porous adsorbent base.
